(19) United States
(12) Patent Application Publication
(10) Pub. No.: US 2021/0052106 A1
(43) Pub. Date: Feb. 25, 2021

(54) ENERGY SAVING SYSTEM FOR PRODUCING COOLED AND HEATED LIQUID

(71) Applicant: BILLI AUSTRALIA PTY LTD, Thomastown, Victoria (AU)

(72) Inventor: LYNTON MCKAY, THOMASTOWN , VICTORIA (AU)

(21) Appl. No.: 16/958,282

(22) PCT Filed: Dec. 21, 2018
(86) PCT No.: PCT/AU2018/051399

§ 371 Date: Jun. 26, 2020

(30) Foreign Application Priority Data
Dec. 27, 2017 (AU) 2017905198

(51) Int. Cl. A47J 31/56; B67D 1/08; F25B 29/00; F24H 4/02; F25B 1/04; F25B 41/04; F25D 31/00

(52) U.S. Cl. CPC A47J 31/56; B67D 1/0858; B67D 1/0895; F25B 29/003; F24H 4/02; F25D 31/005; F25B 41/04; F25D 31/002; F25B 2339/046; F25B 2339/047; F25B 2600/0261; F25B 1/04

(57) ABSTRACT

A system for producing a cooled liquid and a heated liquid. Such a system may be embodied in the form of a unitary apparatus configured to dispense chilled water and near boiling water for human consumption. In one form, there is provided a system for heating and cooling a liquid, the system including: a liquid cooling unit having a heat output component, and a first liquid heater configured to hold and heat a liquid. The first liquid heater is configured to retain a first body of the liquid about the heat output component such that the liquid is heated, and furthermore that a temperature gradient is formed and maintained within the first body of the liquid.

### FIELD OF THE INVENTION

The present invention relates generally to the field of systems used for producing a cooled liquid, and a heated liquid. Such systems may be embodied in the form of a unitary apparatus configured to dispense chilled water and near boiling water for human consumption. In particular, but not exclusively, the present invention may be embodied in the form of electrically powered on-bench or under-bench combination water heater and chiller.

### BACKGROUND TO THE INVENTION

Significant convenience is provided by prior art water heating and chilling units of the type found in domestic kitchens and office tea rooms.

These units provide instant access to heated water for coffee and tea on demand by the user simply actuating an outlet valve to dispense the water via a spout. Generally, municipal water coming into the unit enters an insulated tank where it is heated by way of an electrical resistance coil. The electrical heating capacity of the coil is designed to be sufficient to accommodate the expected volume of heated water required in the course of a day, and having regard to the often increased needs at tea and lunch times. Even very well designed heaters consume significant amounts of energy to ensure that near boiling water is available when required. While thermal insulation is used to limit standing heat losses, it is inevitable that there will be some loss of energy, with the corollary that intermittent reheating of water will be required to ensure that sufficiently heated water is available on demand. It is problem in the art to provide heated water available on demand, and with reduced energy input.

With regard to the provision of chilled water, prior art units typically comprise either an insulated water tank or a solid mass heat storage block which is cooled by a refrigeration system evaporator coil. Typically, a cooling circuit containing a refrigerant is provided, with compressed refrigerant in a liquid state drawing thermal energy from water in the insulated tank, and in the process returning to a gaseous state. The gaseous refrigerant is the condensed back to the liquid state, with the concomitant release of heat to the atmosphere. For efficient operation of the condenser, the released heat must be conveyed away from the condenser with this often achieved by simple convection means or in some instances facilitated by a fan.

Where the unit is installed in a confined location (such as in a cupboard), there may be some difficulty in maximizing the conveyance of heat from the condenser. Accordingly, it is a problem in the art to provide for improved efficiency in condenser operation.

It is an aspect of the present invention to overcome or alleviate a problem of the prior art by providing a system that is capable of heating and chilling a liquid with a higher energy efficiency. It is a further aspect to provide a system that lessens the possibility of the water heated to a less than desired temperature from being dispensed to a user. It is a further aspect to provide a useful alternative to the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system for heating and cooling a liquid, the system comprising: a liquid cooling unit comprising a heat output component, a first liquid heating means configured to hold and heat a liquid; wherein the first liquid heating means is configured to retain a first body of the liquid about the heat output component such that the liquid is heated, and furthermore that a temperature gradient is formed and maintained within the first body of the liquid.

In one embodiment of the first aspect, the first liquid heating means comprises a first vessel having a floor and a wall and the heat output component extends into the interior of the vessel.

In one embodiment of the first aspect, the liquid cooling unit is a condenser, and the heat output component is a condenser coil.

In one embodiment of the first aspect, the condenser coil extends for most or substantially all of the liquid depth within the first vessel.

In one embodiment of the first aspect, the temperature gradient is defined by a lower temperature in a lower region of the first body of the liquid, and a higher temperature is an upper region of the first body of the liquid.

In one embodiment of the first aspect, the system comprises a liquid entry port located so as to admit liquid in a lower region of the first body of the liquid.

In one embodiment of the first aspect, the first vessel has a ceiling.

In one embodiment of the first aspect, the system comprises means to cause or allow exit of liquid from an upper region of the first body of the liquid.

In one embodiment of the first aspect, the means to cause or allow exit of liquid from an upper region of the first body of the liquid (where present) is a discontinuity in or about the ceiling configured to cause or allow exit of water from the first vessel.

In one embodiment of the first aspect, the discontinuity is a space between the wall and the ceiling, or an aperture within the ceiling.

In one embodiment of the first aspect, the system comprises a second vessel configured to hold a second body of the liquid, wherein first and second vessels are in liquid communication so as to cause or allow liquid of the first body of the liquid to pass into the second vessel.

In one embodiment of the first aspect, the second vessel is disposed above first vessel.

In one embodiment of the first aspect, the ceiling of the first vessel forms the floor of the second vessel.

In one embodiment of the first aspect, the system comprises a heater configured to heat the second body of the liquid held by the second vessel.

In one embodiment of the first aspect, the heater is configured to heat the second body of the liquid to at least about 70° C., or to near boiling.

In one embodiment of the first aspect, the system comprises a single tank configured to maintained substantially separately a first body of the liquid and a second body of the liquid, the second body disposed above the first body, the system configured such that liquid from the first body is caused or allowed to move at a restricted rate into the second body, wherein the first and second bodies are substantially thermally insulated from each other.

In one embodiment of the first aspect, the substantial thermal insulation between the first and second bodies is provided by a baffle to prevent or inhibit bulk mixing of the liquid between the first and second bodies of the liquid while still causing or allowing liquid from the first body to move at a restricted rate into the second body.

In one embodiment of the first aspect, there is a space between the tank wall and an edge of the baffle the combination of baffle and space functioning to prevent or inhibit bulk mixing of the liquid between the first and second bodies of the liquid while still causing or allowing liquid from the first body to move at a restricted rate into the second body.

In one embodiment of the first aspect, the baffle comprises a heating element configured to heat the second body of the liquid.

In one embodiment of the first aspect, the heating element is configured to heat the second body of the liquid to at least about 70° C., or to near boiling.

In one embodiment of the first aspect, the system comprises a liquid exit port located so as to cause or allow liquid to be drawn from the first or second body of the liquid.

In one embodiment of the first aspect, the system comprises a dispenser spout in liquid communication with the exit port.

In one embodiment of the first aspect, the system comprises a heated water storage tank in liquid communication with the exit port.

In one embodiment of the first aspect, the heated water storage tank comprises a heater configured to heat water contained therein to at least about 70° C., or to near boiling.

In one embodiment of the first aspect, the system comprises a dispenser spout in liquid communication with the heated water storage tank.

In one embodiment of the first aspect, the system comprises insulation configured to retain heat energy about a tank or a vessel of the system, where present.

In one embodiment of the first aspect, the system comprises any one of more of a valve, a solenoid, a level sensor, an electrical switch, a drain, a conduit, a heater and a pump configured to cause or allow: the admission of an input fluid to form the first body of liquid, and preheating the first body of liquid.

In one embodiment of the first aspect, the system has a first body of the liquid and a second body of the liquid, and any one of more of a valve, a solenoid, a level sensor, an electrical switch, a heater, and a pump such that the drain, conduit, and a pump, the any one of more of a valve, a solenoid, a level sensor, an electrical switch, a heater, and a pump is/are configured to cause or allow movement of liquid from the first body of liquid to the second body of liquid and further heating of the second body of liquid.

In one embodiment of the first aspect, where the system has a first body of the liquid and a second body of the liquid, and any one of more of a valve, a solenoid, a level sensor, an electrical switch, a heater, a drain, a conduit, and a pump, the any one of more of a valve, a solenoid, a level sensor, an electrical switch, a heater, a drain, a conduit, and a pump (where present) is/are configured to cause or allow movement of liquid from the second body of liquid to (i) a dispensing spout or to (ii) another vessel for storage and optionally further heating.

In one embodiment of the first aspect, the system comprises a data processor configured to accept input data or signal from an input device such as a level sensor or a switch, and provide an output signal or data configured to actuate an output device such as a valve or a pump or a heater.

In one embodiment of the first aspect, the system is embodied in the form of a unit configured to dispense heated and cooled water for use as a beverage.

In one embodiment of the first aspect, the system comprises a spout with associated user actuation means configured to dispense on demand a heated liquid or a cooled liquid from the spout for use as a beverage.

In a second aspect, the present invention comprises a method of obtaining a heated liquid or a cooled liquid for use as a beverage, the method comprising the step of actuating the user actuation means of any embodiment of the system of the first aspect.

In one embodiment of the second aspect, the heated liquid or cooled liquid is water, or an impure water, or a substantially aqueous solution of a solute, or a substantially aqueous suspension of a material.

### BRIEF DESCRIPTION OF THE DRAWINGS

FIG. 1 is a lateral cross-sectional diagram of a preferred system of the present invention being a heated and chilled water system. A part of the system is comprised generally of a single tank divided into an upper vessel and a lower vessel. Water is preheated in the lower vessel using a condenser coil of the chilled water circuit of the system before moving to the upper vessel for further heating. The further heated water in the second vessel is passed to a third vessel for heating to near boiling temperatures. Near boiling water for a beverage is drawn from the third vessel.

The general direction of water movement is shown by the dashed arrows. The elements in the diagram are not drawn to scale, or with regard to any precise positioning in relation to other elements.

FIG. 2 is a lateral diagram of an embodiment of the invention modified to include elements which control the location of liquid refrigerant when the refrigeration circuit compressor is switched off so as to prevent refrigerant migrating.

The arrows parallel to the conduits represent the flow of refrigerant therein.

### DETAILED DESCRIPTION OF THE INVENTION INCLUDING PREFERRED EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

Furthermore, it is not represented that all embodiments display all advantages of the invention, although some may. Some embodiments may display only one or several of the advantages. Some embodiments may display none of the advantages referred to herein.

In a first aspect, the present invention provides a system for heating and cooling a liquid, the system comprising: a liquid cooling unit comprising a heat output component, a first liquid heating means configured to hold and heat a liquid; wherein the first liquid heating means is configured to retain a first body of the liquid about the heat output component such that the liquid is heated, and furthermore that a temperature gradient is formed and maintained within the first body of the liquid.

Applicant has found that the establishment of a temperature gradient in a means for preheating water in the heating circuit of a combination water heater/cooler unit provides advantage in that relatively hot water may exit from the relatively high temperature regions of the gradient, leaving relatively cool water further time to warm in the relatively low temperature regions of the gradient. The water exiting from the relatively high temperature regions of the temperature gradient may then be exposed to a dedicated heater within the system that further increases the temperature to near boiling temperatures. Given that the water is preheated (exiting from relatively high temperature regions of the temperature gradient), the dedicated heater is required to consume less energy to bring the water to near boiling temperature as compared with the circumstance where the water is not preheated.

As used herein, the term “near boiling temperature” in intended to include temperatures at which a human beverage consumer generally prefers the temperature of a beverage (when freshly prepared), or generally prefers to prepare a beverage. Exemplary temperatures are at least about 90, 91, 92, 93, 94, 95, 96, 97, 98 and 99° C. In many commercially available heated and chilled water units, the temperature of heated water dispensed therefor is typically about 98° C. As will be appreciated, this temperature of 98° C. can be varied according to the needs of any particular application.

As will be appreciated, in some instances a cooler beverage temperature may be desired. For example green tea is preferably brewed as low as 72° C. Lower temperatures may be achieved by decreasing a thermostat setting of the water heating element, or preferably by mixing near boiling water with cooler water as described more fully infra.

The first liquid heating means may be configured such that the temperature gradient is allowed to form passively by allowing water heated by the first liquid heating means to rise to an upper region within the liquid. As will be appreciated, the first liquid heating means is preferably configured to prevent, or at least inhibit, mixing of the water held by it so as to prevent interference in the temperature gradient.

Establishment of the temperature gradient may be established by heating upper regions of the first body of water in preference to lower region. For example, the heat output component may disposed in an upper region of the first body of water, or the heat output component may be capable of selectively heating an upper region of the first body of water.

In the context of a combination system for heating and cooling water, the heat output component (which heats the first body of water held by the first liquid heating means) may be a condenser coil of a condenser used in the cooling circuit of the system, and the hot gas inlet of the coil may be disposed within an upper region of the temperature gradient so as to rapidly heat liquid in the relatively high temperature region of the gradient. In this way, relatively hot preheated water is readily available to be drawn for use in the dedicated heater of the system.

In this arrangement, most of latent heat of vaporisation held by the hot gas of the condenser coil will, however, be given up to the water in the lower regions of the temperature gradient given the presence of relatively low temperature water therein. Upon transfer of the latent heat energy to water in the lower regions, the water is heated and will rise to upper regions of the gradient.

As an alternative, the system may be configured such that the hot incoming gas within the condenser coil is first exposed to relatively low temperature water in the lower regions of the temperature gradient so as to rapidly heat that water and cause it to rise to the upper regions of the gradient. In this embodiment, the latent heat of vaporisation held by the condenser gas is given up to the water relatively early, with less heat energy available to elevate temperature of water in the upper regions of the temperature gradient.

In the arrangement outlined above the condenser coil may traverse most, or substantially all of the temperature gradient such that an upper region of the coil is within an upper region of the temperature gradient and a lower region of the coil is within a lower region of the temperature gradient.

As will be appreciated, heated water which exits from the first liquid heating means will typically be replaced with incoming water. Generally, incoming water is provided by connection of the first liquid heating means to the main municipal water supply. It preferred that the system be configured such that incoming water does not substantially interfere with the temperature gradient established in the first body of water. This aim will typically be achieved by configuring the system to introduce incoming water (which is normally at ambient temperature) into the lower regions of the temperature gradient where the water is at a relatively low temperature. Introducing ambient temperature water into an upper region of the temperature gradient would lower the ΔT of the gradient. Furthermore, the ambient water (being cooler that the heated water in the upper gradient region) would rapidly sink to the lower gradient regions thereby disadvantageously mixing water in the upper and lower gradient regions.

Thus, any water inlet into the first body of water is preferably configured to minimise disturbance of the temperature gradient. For example, the inlet may be configured to limit the pressure of incoming water. In addition or alternatively, the inlet may be configured to direct the incoming water substantially horizontally so as to limit the amount of vertical mixing within the first water body. In some situations it may be desirable for the system to include means for trapping any air in incoming water given the propensity for air bubbles to cause significant mixing and destruction of the temperature gradient.

The ΔT achievable by the present system within the first body of water will depend at least to some extent on the amount of latent heat energy provided by the coil, the volume of water in the first body of water, any inadvertent mixing in the first body of water, the depth of the first body of water, the volume of heated water dispensed by the system in any time period and the like. In some embodiments the system the ΔT achievable by the present system within the first body of water is at least about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 48, 49 or 50° C.

An aim of the first water heating means is to preheat water to at least some extent so as to decrease the energy required at following heating step. While the temperature gradient provides advantage in that relatively well heated water is preferentially drawn (leaving less well heated water to remain in contact with the condenser coil until the time that it is also relatively well heated), the system will nevertheless provide advantage where even a small ΔT is achieved. Lager ΔT values are preferred, however, given that this is indicative of a system that is capable of providing water at a relatively high absolute temperature. As will be appreciated, a system having a relatively low ΔT value can provide water at the upper temperature limit that is relatively low, because of a lesser ability to concentrate heat in a small volume of water. By contrast in a high ΔT value system, water can be provided at the upper temperature limit at a relatively high temperature, because of a greater ability to concentrate heat in a small volume of water.

Thus, in a higher ΔT system, the heat energy from the condenser is concentrated into a small volume of water in the uppermost region of the temperature gradient. This water having a high concentration of heat (i.e. a high absolute temperature) is passed into the main heating vessel and has a much lesser effect on lowering the temperature of the water in the main heating vessel upon entry.

For example, a high ΔT system may be able to preheat water to a temperature of 60° C., while a low ΔT system may be capable of heating water to a maximum temperature of only 30° C. Water in the main heating vessel may be at 98° C., with admission of a set volume of preheated water at 60° C. leading to a decrease to say 95° C. In contrast, admission of the same volume of water at 30° C. would decrease the temperature of the water in the main heating vessel to 92° C. It will be apparent that the heater in the main heating vessel will require more energy to heat the water in the main heating vessel back to 98° C. when the preheated water is admitted at a temperature of 30° C. compared with preheated water at 95° C.

In beverage dispensing units, near boiling water is typically drawn by the user in small volumes intermittently during the day. Thus, a small volume of high temperature water that may be provided by the first water heating means of the present system may be well used to replace a small volume of near boiling water dispensed from the main heating vessel of the system.

In one embodiment the first liquid heating means is configured to heat water to a temperature of at least about 20, 21, 22, 23, 24, 25, 26, 27, 28, 29, 30, 31, 32, 33, 34, 35, 36, 37, 38, 39, 40, 41, 42, 43, 44, 45, 46, 48, 49, 50, 51, 52, 53, 54, 55, 56, 57, 58, 59, 60, 61, 62, 63, 64, 65, 66, 67, 68, 69 or 70° C. In one embodiment the first liquid heating means is configured to heat water by at least about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 48, 49 or 50° C.

From the above, it will be appreciated that at least in some embodiments the present system provides means for more effectively recovering the heat output of a condenser in a combined water chilling and heating unit. The recovered heat is used to preheat water in a first vessel that is passed to a main heating vessel. The main heating vessel may be considered as a second vessel of the system, the second vessel comprising a second body of water, as further described infra.

In some embodiments of the invention it is preferred to introduce elements which control the location of liquid refrigerant when the refrigeration circuit compressor is switched off.

Performance testing of a rotary compressor, with the condenser coil located within a hot water preheat vessel, and the evaporator coil located within a solid aluminium heat exchange block was conducted. The testing involved a draw off of 200 ml cups of cooled water every 20 seconds with the mains water supply temperature at 23° C. The outlet target temperature was 10° or less.

The first several cups were clearly cold, however the temperature of subsequent cups rose until about the 20th cup at which point the water temperature had risen to over 14° C. The outlet temperature then began to drop with each successive cup. At the 66th cup, the outlet temperature was down to 10.0° C. By 122nd cup, outlet temperature had stabilized and each successive cup drawn was 8.3° C. It was evident that the refrigeration cooling effect took several minutes to reach full performance.

Applicant discovered that for the system as tested, when the compressor stopped, all of the liquid refrigerant in the system would naturally migrate to the coldest region, which, as with all refrigeration systems, is the evaporator aluminium block coil. This migration had two consequences. Firstly, when the compressor started to run again, a proportion of the liquid refrigerant from the evaporator ran directly to the compressor causing it to lug liquid, which is contraindicated for a rotary type compressor.

The second effect was that the condenser was now empty of refrigerant liquid. With no liquid refrigerant available, there was none to evaporate in the evaporator coil and hence, initially, there was no cooling effect. Suction pressure dropped and head pressure stayed low. It was necessary to run the compressor for several minutes for the refrigerant gas to condense and produce sufficient liquid to start flowing smoothly through the capillary. Over several minutes, head pressure gradually increased, thereby increasing refrigerant flow through the capillary and increasing cooling performance. It was found that as soon as the compressor was stopped (and for as little time as one minute) the same affect would repeat.

To address the condition described, a method of trapping the liquid refrigerant within the condenser when the compressor stopped was needed. In one solution identified, a solenoid valve was inserted into the liquid line after the condenser, and before the capillary. The solenoid valve is normally closed and the coil is electrically connected in parallel with the compressor. As soon as the compressor stops, the valve closes. As this would have the effect of preventing high and low sides equalizing when the compressor stopped, a second solenoid valve (being a hot gas bypass valve) was fitted to release the compressor head pressure into the suction line when the compressor stopped. This solenoid valve is normally open and the coil in electrically connected in parallel with the compressor. As soon as the compressor stops, this valve opens and the gas head pressure is released directly into the compressor suction line. To prevent the liquid refrigerant flowing back through the open solenoid valve, an inline check valve was fitted in the discharge line, after the branch to the head pressure relief solenoid valve.

By this arrangement, the chiller responds quickly to commence cooling water once the compressor starts. As the condenser is filled with liquid, the refrigeration cooling effect starts almost immediately and suction pressure does not drop greatly. Head pressure rises quickly allowing good refrigerant flow.

As the head pressure in the compressor is completely released as soon as relief solenoid valve opens, the compressor can be started almost instantly, even after a several seconds after stopping. Standard refrigerated water chilling systems of this type, typically require a time delay of at least a minute before the internal pressure have sufficiently equalized to allow the compressor motor to start.

Overall, the performance and efficiency of the system fitted with the solenoid and check valves is improved (and in some embodiments substantially improved) as compared to the same or similar system without the valves arranged as described above.

Water may exit from the first vessel by any means deemed suitable by the skilled person having benefit of the disclosure herein. In one embodiment, the second vessel is in fluid communication with the first vessel such that exit of water from the second vessel causes water from an upper region of the first vessel to pass into the second vessel (and preferably a lower region of the second vessel). In one embodiment, exit of water from the second vessel (say, due to dispensing of near boiling water from the second vessel) triggers opening of an inlet valve allowing entry of mains supply water (under pressure) into the first vessel thereby displacing heated water from the first vessel into the second vessel. When the dispensing is ceased, the inlet valve closes and the flow of water from the vessel to the second vessel ceases.

Advantageously, the second vessel is disposed above the first vessel such that heated water at the top region of the first vessel flows upwardly to the bottom region of the second vessel. This arrangement may be achieved by providing a single tank having a substantially horizontal divider disposed therein so as to divide the tank into the two vessels of the system. The lower vessel is the first vessel of the system (functioning to preheat incoming water), and the upper vessel is the second vessel of the system (functioning to further heat the preheated water up to a storage temperature, or to near boiling).

Preferably, the divider is configured so as to prevent heat transfer from the second body of water in the second vessel to the first body of water in the first vessel. In this way, the system is required to heat only water that may be immediately required for dispensing, and not also water in the first vessel is being preheated. The divider may be fabricated from a thermally insulating material, or may comprise a cavity having air evacuated therefrom.

In one embodiment of the system a single tank is provided with the divider acting to divide the tank into a first (lower) vessel and a second (upper) vessel. Liquid communication between the first and second vessels may be provided by any means causing or allowing liquid to exit the first vessel and enter the second vessel. Preferably the liquid communication means is a discontinuity, an aperture, apertures, a plurality of apertures, or a grating of the divider.

In one embodiment the means for causing or allowing exit of water from the first vessel to enter the second vessel is one or more spaces between the divider edge and the interior surface of the tank. The space may extend substantially the entire periphery of the divider, the space being interrupted by point of attachment between divider and the tank wall. In this embodiment, the divider may be considered a baffle that acts to prevent bulk movement of liquid between the two vessels, but causes or allows water from the lower vessel to migrate upwardly only about the periphery of the tank and into the upper vessel. The space between the divider edge and the tank wall is less than about 1, 2, 3, 4, 5, 6, 7, 8, 9, 10, 11, 12, 13, 14, 15, 16, 17, 18, 19 or 20 mm.

In one embodiment, the divider comprises an electrical resistance heating element configured to selectively heat water in the upper vessel preferentially to the water in the lower vessel. The preferential heating may be effected by the presence of thermal insulation or a thermal energy reflector that prevents or inhibits heating of water in the lower vessel. The heating element is capable of elevating the temperature of the water in the upper vessel to a desired temperature. In one embodiment, the heating element heats the water up to a final desired temperature, such as 98° C., as is comment in water heaters used to provide water for coffee and tea.

In other embodiments, the heating element heats the water to a temperature that is lower than a desired temperature with the water then stored at the temperature. For example, the water may be heated to 70° C. and stored at that temperature. At a later time, the 70° C. water is transferred to a final vessel where it is heated to 98° C. for dispensing to a user.

It will be understood that thermal insulation will typically be provided on or about exterior surfaces of the system including any tank, vessel, conduit, pump, or valve. The thermal insulation functions so as to lessen the loss of thermal energy held water held within the system.

The present system may comprise a level sensor, electric pump, valve, mixer valve, heater and the like. Preferably, such devices are controllable by electric or electronic means so as to allow automated operation of the system.

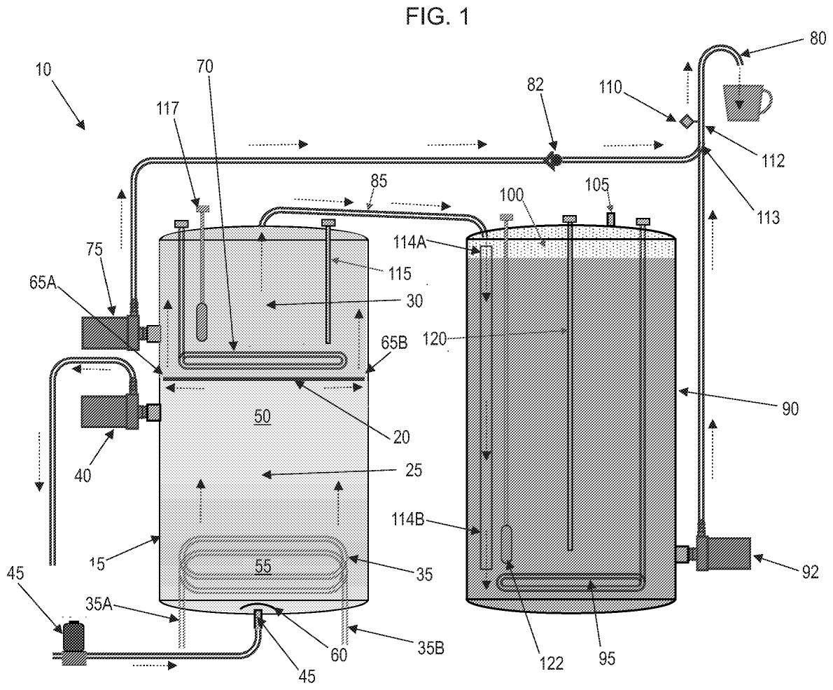

Reference is now made to a preferred system of the invention configured as an under-bench or on-bench electrically-powered unit for providing small volumes (cup size, mug size, or drinking glass size) volumes of beverage to a human user, as shown in FIG. 1. Exemplary volumes are between about 50 ml and about 500 ml. The system is configure to dispense both heated and cooled water, however for the sake of clarity only the condenser coil of the water cooling circuit is shown.

The system (10) comprises a first tank (15) being generally cylindrical and fabricated so as to hold heated water therein. The tank (10) has a baffle (20) which essentially divides the tank (15) so as to provide a lower vessel (25) and an upper vessel (30).

The lower vessel (25) is essentially filled with water which surrounds the coil (35) of a refrigeration condenser. The inlet and outlet pipes (35A) and (35B) respectively extend through the floor of the tank (15). In reality, the condenser coil (35) extends upwardly almost to the lower face of the baffle (20).

Upon activation of the water cooling circuit (not shown) of the system (10), the condenser commences extraction of thermal energy from water to be cooled. The extracted thermal energy causes a refrigerant liquid within the refrigerant circuit to expand and transform into the gaseous phase. The gaseous refrigerant is moved by compressor means through the condenser coil (35) where it is cooled by the water in the water surrounding the coil (35) and thereby returned to the liquid phase. Where water in the lower vessel (25) is warmed to the point that it is unable to receive any further appreciable heat energy, the pump (40) may be actuated so as to remove water from the tank (15) (and sent to drain) so as to allow the admission of fresh mains water via the solenoid actuated inlet valve (45). This newly admitted water acts to cool the coil 35 thereby facilitating proper operation of the water cooling circuit.

In any event, the transfer of heat energy from the coil (35) into the surrounding water of the lower vessel (25) establishes a temperature gradient in the water. The water in the region marked (50) is relatively warm (typically up to about 60° C.), with the water in the region marked (55) being around ambient temperature (about 20° C.). As discussed elsewhere herein, this water in the upper region of this temperature gradient is significantly preheated, and requires a lesser amount of energy to increase its temperature to near boiling for dispensing to a user.

The gradient is established in part due to the upper region of the condenser coil (35) being the first to receive incoming gaseous refrigerant, and therefore being the hottest part of the coil. As refrigerant moves from the upper regions of the coil (35) to the lower regions, the gas condenses to a liquid. Most or all of the heat energy held in the refrigerant has been lost to the water by the time the refrigerant enters the lower regions of the coil (35), and accordingly there is little or no heating of water in the lower regions of the lower vessel (25).

Establishment of the gradient is further assisted by the natural tendency of heated water to rise. Thus, under ideal conditions the water contacting the lower face of the baffle (20) holds the greatest amount of heat energy of all water in the lower vessel (25).

In order to maintain the temperature gradient, mixing of water in the lower vessel (25) is inhibited as far as possible. There is a propensity for incoming water (via the inlet valve (45)) to disrupt the temperature gradient, and so as to limit any disruption a concave spreader cover (60) is disposed over the inlet port (45). The spreader cover (60) directs incoming water radially and slightly downwardly to minimise mixing with water of a higher temperature in the upper regions of the lower vessel (25). Incoming water is controlled by solenoid valve (47).

As will be noted from FIG. 1 narrow spaces (65A), (65B) exist between the tank (15) wall and the edge of the baffle (20). The spaces (65A), (65B) allow for preheated water from the uppermost region of the lower vessel (25) to the upper vessel (30). This movement of water is typically caused by the admission of water by actuation of the inlet valve (45) so as to push overlying water upwardly and through the spaces (65A), (65B) and into the upper vessel (30).

Preheated water within the upper vessel (30) is further heated to 70° C. by a thermostatically controlled electrical heating element (70). The temperature of 70° C. is considered generally safe for the storage of water, being incapable of supporting microbial replication. Of course, this temperature of 70° C. may be varied according to the particular application at hand. The water in the second vessel may dispensed directly to a user, by a pump (75) conveying water to the dispensing spout (80). For some beverages (for example, herbal teas), water heated to significantly less than boiling temperature is desirable.

The baffle (20) is formed from or includes a thermally insulating material so as to prevent the loss of heat from the upper vessel (30) to water in the lower vessel (25). Transfer of heat in this way would, if permitted to occur, result in the heating element (70) acting to heat all water in the tank (15) including water in the lower vessel (25). Such heating would diminish the ΔT of the temperature gradient of water in the lower vessel (25), thereby negating the energy saving effects of the system as a whole and furthermore inhibiting effective cooling of the condenser coil (35).

The water in the upper vessel (30) may be conveyed via conduit (85) to a main heating tank (90). By the thermostatically controlled heating element (95), the water contained in the main heating tank (90) is heated to near boiling and stored there until required by a user. The pump (92) functions to convey near boiling water to the dispensing spout (80). The main heating tank (90) has a designated head space (100) and a vent pipe (105).

The head space (100) is provided in this preferred embodiment to allow for expansion of the cooler incoming water. When heating water from 20° C. up to 98°, the volume expands by about 4%. With a single tank, all expansion occurs within that tank. In the present system, water begins to be heated in the lower vessel (25), is further heated in the upper vessel (30), and further heated in the main heating tank (90) with expansion due to heat occurring at each stage. Any expansion in tank (15) (i.e. lower vessel (25) or upper vessel (30)) overflows via conduit (85) into main heating tank (90). The head space (100) also provides a buffer area so if the water boils, water is prevented from spurting out of the tap.

The main heating tank (90) comprises a vertical conduit (114) which at the upper end (114A) admits pre-heated water from the conduit (85) and discharges that water at the lower end (114B) into the lower region of the main heating tank (90). As will typically be the case, water expelled from conduit (85) will be cooler than water in the main heating tank (90) (for example 70° C. versus 90° C.). The relatively cool water will gradually sink downwardly toward the lower region of the main heating tank (90) thereby mixing with surrounding water and lowering the overall temperature of water in the main heating tank (90). As the temperature sensor (122) is located toward the bottom of the tank, it would only be after some time that the temperature sensor (122) would detect the lowered temperature and trigger heating to commence (via element (95)) and in which time the water temperature throughout the tank may have dropped significantly. The vertical conduit (114) directs the incoming relatively cool water downwards and to the lower region of the main heating tank (90). In some embodiments, it may be preferable for the vertical conduit (114) to discharge water proximal to the temperature sensor (122) to allow the heating element (95) to respond more rapidly to the cooling effect of the incoming water.

The upper end (114A) of the vertical conduit extends above the maximum water level in the main heating tank (90) by, say 15 mm, while still leaving an air gap between the conduit (85). Thus, relatively cool 70° C. water entering main heating tank (90), flows into the upper end (114A) of the conduit. Natural convection causes the water within the conduit to move downwardly, this downward movement aided by the 15 mm of head that would form. The lower end (114B) of the conduit is preferably located distal to the inlet of pump (92) so that as the heating element (95) is turned on, the incoming water is drawn into the rising convection stream created by the element (95) therefore avoiding a “short circuit” water flow across to the pump (92) inlet.

A temperature sensor (110) is provided to sense temperature of water in the outlet conduit (112). Water in the outlet conduit (112) may originate solely from the main heating tank (90), and therefore be at near boiling, or originate solely from the upper vessel (30), and therefore be at a temperature of around 70° C. Alternatively, the water in the outlet conduit (112) may be drawn from both upper vessel (30) and the main heating tank (90) and therefore be at an intermediate temperature. To dispense near boiling water a hot tap lever (not shown) is pressed by the user, pump (92) runs so as to draw water from tank (90) and conveys that water through outlet conduit (112) to dispenser spout (80). After the hot tap lever is released, pump (92) stops and hot water remaining in the outlet conduit (112) runs back by gravity, through pump (92) into tank (90).

To deliver hot water but at a reduced temperature, pump (75) runs to convey 70° C. water from the upper vessel (30) to the outlet conduit (112). At the same time pump (92) runs to convey 98° C. water from main heating tank (90). The two streams of water combine at outlet tube (112) intersection (113) to form water at a temperature between 70° C. and 98° C. Both pumps (75) and (92) are powered by a brushless DC electric motors and the speed of each pump can be accurately controlled by varying the DC supply voltage to each pump (75), (92). By carefully controlling the speed of each pump (75), (92), varying proportions of each temperature water is mixed and water at a user selected temperature is delivered from the dispenser spout (80). The pump speeds for a given outlet temperature are selected with reference to an look-up chart stored in electronic memory The outlet temperature sensor (110) is a rapid response type and is used to monitor the mixed hot water outlet temperature as it is being dispensed. If the sensed temperature is different from the selected temperature, the pump speeds are instantly altered to correct the variance. After each time a temperature correction is applied, system software adds a small correction factor to the look up table. In this way, over time, the pumps speed settings for a given temperature are automatically calibrated.

Both the second vessel (30) and main heating tank (90) have level sensor probes (115), (120) respectively and also temperature sensors (117), (122) respectively which provide system input via microcontroller means (not shown). Depending on changing levels reported by the sensor probes (115), (120) the level of water may be regulated. For example, upon dispensing of water via the spout (80), the water level in the main heating tank (90) and/or upper vessel (30) will decrease thereby necessitating the admission of fresh mains water via microcontroller-mediated opening of the solenoid input valve (45). Once water levels are replenished, the microcontroller instructs the solenoid inlet valve (45) to close. The level sensors (115), (120) furthermore have a safety function in so far as heating element (70) or (95) may be inactivated where the level of water decreases to a predetermined minimum.

Also incorporated into the preferred system of FIG. 1 is a reverse flow check valve (82). The purpose of check valve (82) is two-fold. After hot water is delivered to outlet spout (80), whether it has been drawn from the upper vessel (30) only at 70° C., or a mixed stream from upper vessel (30) and main heating tank (90) or from the main heating tank (90) only, the water remaining in the outlet conduit (112) always runs back into main heating tank (90), the check valve (82) preventing flow back into upper vessel (30). When 98° C. water is drawn from main heating tank (90), pump (92) runs so as to convey water the outlet conduit (112). The check valve (82) prevents the stream from running into upper vessel (30) and instead directs it toward the outlet conduit (112). When mixed hot water is selected (between 70° C. and say 95° C.), both pumps (75) and (92) are running. For water at 70° C., pump (75) runs at 100% duty and pump (92) runs at around 45% which is just sufficient to prevent the 70° C. water from running back into main heating tank (90).

Alternatives to the system shown in FIG. 1 are contemplated. As one alternative, the system may be devoid of main heating tank (90), and in which case the heating element (70) is configured to heat water in the upper vessel (30) to near boiling. In some embodiments, the heating element (70) may be incorporated into the baffle (20) with an insulating layer inferior to the heating element further incorporated into the baffle so as to prevent the element from heating water in the lower vessel (25).

Normal operation of the various components of the system (10) as shown in FIG. 1 is now provided. When the system (10) is running in normal operating mode, and chilled water has been drawn from the dispensing spout (80), the refrigeration compressor (not shown) is started. Heat removed from the water by the evaporator coil (not shown), is rejected through the condenser coil (35), which is located in the lower vessel (25). Water in lower vessel (35) is thus heated and can reach up to around 60° C.

As the water temperature in the lower vessel (35) rises, the head pressure of the refrigeration system (the coil of which is marked (35)) increases, causing the compressor to expend greater work energy. A temperature sensor (not sown) is attached to the liquid refrigerant line, after the condenser coil (35), to monitor this condition.

In a typical higher use installation such as an office kitchen/breakout area, there may be roughly equal amounts of chilled and hot water drawn from the unit during the day. As hot water is drawn via the spout (80), the water level in the main heating tank (90) falls, as detected by level sensor (120). The electronic system controller (not shown) activates the solenoid water inlet valve (45). Cold main water is fed into the lower vessel (25), and preheated water at the top of the upper vessel (30), overflows through the conduit (85) into the main heating tank (90). When the water level in the main heating tank (90) reaches the full level as detected by level sensor (120), the water inlet valve (45) is closed.

The incoming cold water into the lower vessel (25) allows the condenser coil (35) to transfer the heat from the refrigeration system into the newly admitted cold water. This allows the compressor (35) to run efficiently and prevents the compressor head pressure from increasing significantly.

If the volume of chilled water drawn via spout (80) is substantially greater than the volume of hot water are drawn, there may be insufficient cold water entering the lower vessel (25), to cool the condenser coil (35) effectively. The temperature of the liquid refrigerant leaving the condenser gradually increases and the head pressure rises.

When the liquid refrigerant reaches a pre-determined temperature, drain pump (40) is switched on. Water temperature in the region of the pump (45) inlet will be around 60° C. The inlet to pump (45) is located approximately two-thirds of the way up from the bottom of the lower vessel (25), and below the upper few condenser coils. Pump (40) draws water from this region of the lower vessel (25), and conveys it either directly to the drain, or alternatively passed through a fan-cooled coil (not shown), where the heat is removed. The cooler water exiting the fan-cooled coil is fed back into the inlet (45) of the lower vessel (25), thereby forming a circulation loop between the inlet (45) and the inlet to pump (40).

If the 60° water in the upper region of the lower vessel (25) is conveyed to the drain, the water level in the upper vessel (30) drops as detected by level sensor (115). Air is drawn in through the vent pipe (105) in the main heating tank (90), via the conduit (85), into the air space which has been created at the top of the upper vessel (30).

When the water level in the upper vessel (30) has dropped to a pre-determined point as detected by level sensor (115), the system controller opens the cold water inlet valve (45). This newly admitted water enters the lower vessel (25) and acts to increase the water level in the upper vessel (30). The water level in the upper vessel (30) increases up to a second predetermined water level point, which is slightly lower than the point at which water starts to overflow into the main heating tank (90).

The fresh cold water that has entered the lower vessel (25), cools the refrigeration condenser coil (35). When the temperature of the liquid refrigerant from the coil (35) drops to a lower pre-determined point, the drain pump (40) is switched off by the system controller.

The operation described above may continue in a cyclic manner until the chilled water temperature has dropped to a lower set point, at which, the compressor is turned off.

If boiling water is then drawn via the dispensing spout (80), water level in the main heating tank (90) drops, and level sensor (120) triggers (via the system controller) the feed solenoid water valve (45) to open. The level of water in the upper vessel (30) increases from the previous high level until it overflows into the main heating tank (90). Air from the top of main heating tank (90) is displaced through the conduit (85) until the upper vessel (30) is full.

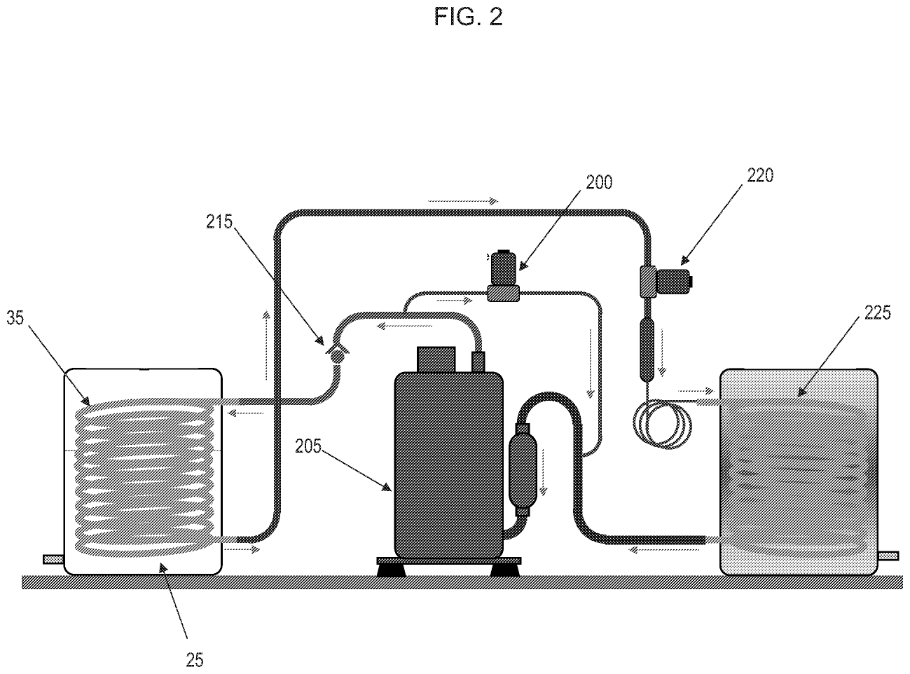

Reference is made now to FIG. 2 which shows an exemplary system modified so as to avoid the problem of delayed cooling after stoppage of the compressor. The compressor coil (35) is disposed within the water preheating vessel (25) (equivalent to the lower vessel marked 25 in FIG. 1). In this modification, there is a solenoid valve (200) (normally open) configured as a head pressure relief valve shunting between compressor (205) output and input. A check valve (215) is disposed inline between the compressor (205) output and condenser coil (35) input to prevent reverse flow of refrigerant.

A second solenoid valve (220) (normally closed) is disposed inline between condenser coil (35) output and the evaporator coil (225) input.

Throughout this specification, reference is often made to water as an exemplary liquid to which the present invention may be applied. It will be understood that the present system is not limited to use with pure water, and may be applied to other comestible liquids such as impure water, water containing any one or more of a carbohydrate, a fat, an oil, a colouring, a flavouring, a salt, a dissolved gas and the like.

Throughout this specification, the functionality of the present invention is described in some parts by reference to a liquid such as water. It will be understood that such references are used to describe the operation of the system or components of the system, or to define functionality of the system or components of the system. It is not represented that any liquid is an essential component of the system. The system will typically be vended without any fluid, with the task of filling the system falling to the user.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the scope of the invention.

1. A system for heating and cooling a liquid, the system comprising:
a liquid cooling unit comprising a heat output component,
a first liquid heating means configured to hold and heat a liquid;
wherein the first liquid heating means is configured to retain a first body of the liquid about the heat output component such that the liquid is heated, and furthermore that a temperature gradient is formed and maintained within the first body of the liquid.

2. The system of claim 1, wherein the first liquid heating means comprises a first vessel having a floor and a wall and the heat output component extends into the interior of the vessel.

3. The system of claim 1, wherein the liquid cooling unit is a condenser, and the heat output component is a condenser coil.

4. The system of claim 3, wherein the first liquid heating means comprises a first vessel having a floor and a wall and the heat output component extends into the interior of the vessel and the condenser coil extends for most or substantially all of the liquid depth within the first vessel.

5. The system of claim 1, wherein the temperature gradient is defined by a lower temperature in a lower region of the first body of the liquid, and a higher temperature is an upper region of the first body of the liquid.

6. The system of claim 1 comprising a liquid entry port located so as to admit liquid in a lower region of the first body of the liquid.

7. The system of claim 1, wherein the first vessel has a ceiling.

8. The system of claim 1 comprising means to cause or allow exit of liquid from an upper region of the first body of the liquid.

9. The system of claim 8, wherein the first vessel has a ceiling and the means to cause or allow exit of liquid from an upper region of the first body of the liquid is a discontinuity in or about the ceiling configured to cause or allow exit of water from the first vessel.

10. The system of claim 9, wherein the discontinuity is a space between the wall and the ceiling, or an aperture within the ceiling.

11. The system of claim 2 comprising a second vessel configured to hold a second body of the liquid, wherein first and second vessels are in liquid communication so as to cause or allow liquid of the first body of the liquid to pass into the second vessel.

12. The system of claim 11, wherein the second vessel is disposed above first vessel.

13. The system of claim 12, wherein the ceiling of the first vessel forms the floor of the second vessel.

14. The system of claim 11 comprising a heater configured to heat the second body of the liquid held by the second vessel.

15. The system of claim 14, wherein the heater is configured to heat the second body of the liquid to at least about 70° C., or to near boiling.

16. The system of claim 1, comprising a single tank configured to maintained substantially separately a first body of the liquid and a second body of the liquid, the second body disposed above the first body, the system configured such that liquid from the first body is caused or allowed to move at a restricted rate into the second body, wherein the first and second bodies are substantially thermally insulated from each other.

17. The system of claim 16, wherein the substantial thermal insulation between the first and second bodies is provided by a baffle to prevent or inhibit bulk mixing of the liquid between the first and second bodies of the liquid while still causing or allowing liquid from the first body to move at a restricted rate into the second body.

18. The system of claim 16, having a space between the tank wall and an edge of the baffle the combination of baffle and space functioning to prevent or inhibit bulk mixing of the liquid between the first and second bodies of the liquid while still causing or allowing liquid from the first body to move at a restricted rate into the second body.

19. The system of claim 17, wherein the baffle comprises a heating element configured to heat the second body of the liquid.

20. The system of claim 1 embodied in the form of a unit configured to dispense heated and cooled water for use as a beverage.
